(19) United States
(12) Patent Application Publication
(10) Pub. No.: US 2009/0064230 A1
(43) Pub. Date: Mar. 5, 2009

(54) Method and Related Device for Switching Channels

(76) Inventor: Chao-Hsin Hung, Taipei County (TW)

Correspondence Address: NORTH AMERICA INTELLECTUAL PROPERTY CORPORATION, P.O. BOX 506, MERRIFIELD, VA, 22116, US

(21) Appl. No.: 12/020,591

(22) Filed: Jan. 28, 2008

(30) Foreign Application Priority Data
Sep. 5, 2007 (CN) 200710149770.2

(51) Int. Cl. G06F 3/00

(52) U.S. Cl. 725/47

(57) ABSTRACT

A method and related device for channel switching includes forming a user list including a plurality of user identities, receiving a channel list corresponding to the user list, wherein the channel list includes a plurality of channel information respectively corresponding to a user identity of the user list, and selecting a channel information from the plurality of channel information of the channel list for broadcasting a TV program corresponding to the channel information according to a user control signal.

### BACKGROUND OF THE INVENTION

1. Field of the Invention

The present invention relates to a method and related device for channel selection, and more particularly, to a method and related device for switching channels in an audio and video broadcast device based on an interactive channel menu including a user list mapping with a channel list.

2. Description of the Prior Art

When a user wants to watch a TV program, he or she may look up a TV channel list for switching to a desired TV channel to enjoy the TV program broadcasted on the TV channel. The TV channel list provides plenty of information about programs broadcasted on each TV channel, and in the recent digital era, the TV channel list can be further developed in an electronic form, such as an electronic program guide (EPG), in addition to traditional paper forms.

However, the conventional electronic program menu is still similar to the traditional paper listings, which simply show the names of TV channels and TV programs broadcasted on the TV channels, and currently, more advanced electronic program menu further provides grouping functions for grouping the TV channels into different categories such as news channels, movies channels, sports channels, and so on. Please refer to FIG. 1, which shows a schematic diagram of a conventional electronic program menu 10. As shown in FIG. 1, the electronic program menu 10 simply includes program time (not shown), a plurality of TV channel names, such as AXN, TVBS, ESPN and etc, and corresponding program information, such as CSI, Hourly news, NBA Lives and etc. With the increase in the number of TV channels, when users try to switch channels, it is hard to make a decision if there are no other references except for the TV program names and short descriptions thereof. Additionally, since most viewers watch TV at their homes, the viewers cannot interact with friends immediately to share their feelings about the content of the TV program broadcasted on the selected TV channel while watching TV.

### SUMMARY OF THE INVENTION

It is therefore to provide a method and related device for switching channels.

The present invention discloses a method for switching channels in an audio and video broadcast device. The method comprises forming a user list comprising a plurality of user identities; generating an interactive channel menu by matching the user list with a channel list comprising a plurality of channel information, wherein a channel information of the plurality of channel information shown on the interactive channel menu varies when one of the user identities corresponding to the channel information switches the channel information; and selecting the channel information from the interactive channel menu to broadcast the same channel information corresponding to the user identity through a user control command.

The present invention further discloses an electronic device for switching channels in an audio and video broadcast device. The electronic device comprises a user list generation module for generating a user list comprising a plurality of user identities; a channel list reception module, coupled to the user list generation module, for receiving a channel list corresponding to the user list, wherein the channel list comprises a plurality of channel information corresponding to the plurality of user identities of the user list, respectively; and a switch module for selecting a channel information from the channel list to control the audio and video broadcast device for broadcasting a TV program corresponding to the channel information according to a user control command, wherein the user list and the channel list corresponding to the user list form an interactive channel menu for being displayed on a screen of the audio and video broadcast device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional electronic program menu.

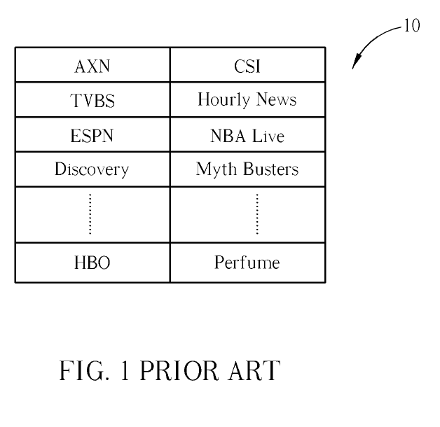

FIG. 2 is a schematic diagram of an embodiment of a process for switching channels in an audio and video broadcast device.

FIG. 3 is a schematic diagram of an example of an interactive channel menu according to an embodiment of the present invention.

FIG. 4 is a schematic diagram of an example of an interactive channel menu according to another embodiment of the present invention.

FIG. 5 is a schematic diagram of an electronic device for switching channels in an audio and video broadcast device according to the present invention.

### DETAILED DESCRIPTION

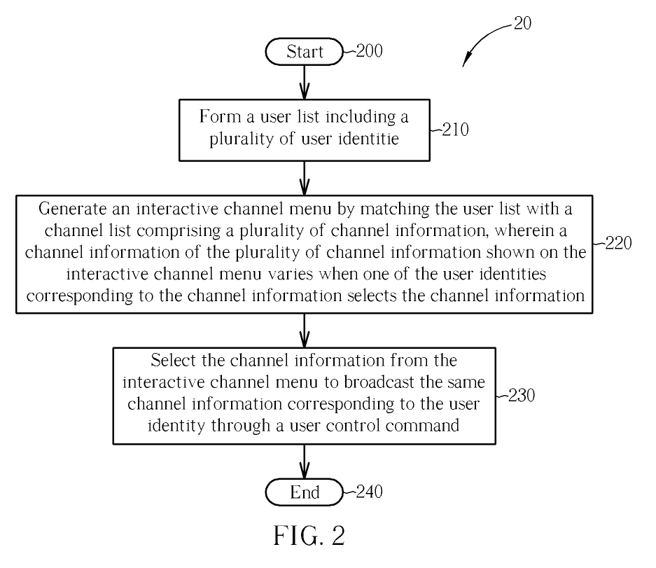

FIG. 2 is a schematic diagram of an embodiment of a process 20 for switching channels in an audio and video broadcast device.

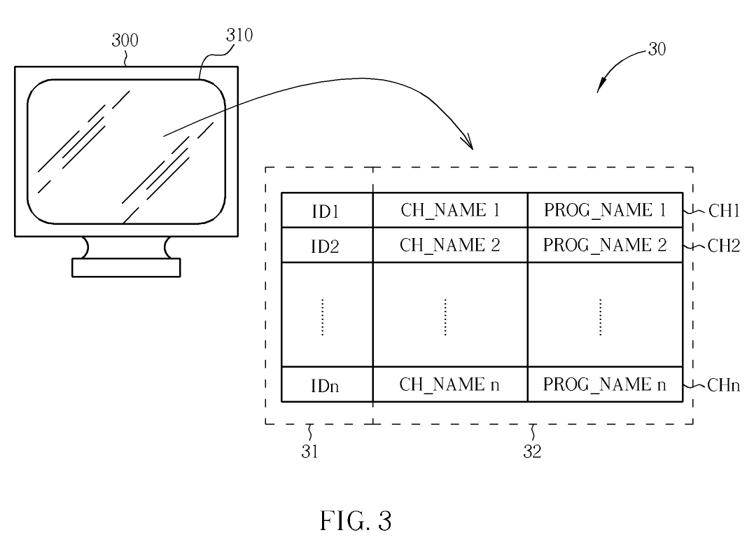

When a user wants to use the audio and video broadcast device to watch a TV program, a user list including a plurality of user identities is formed (step 210). Then, an interactive channel menu is generated (step 220) by matching the user list with a channel list and shown on a display device. The channel list comprises a plurality of channel information such as channel names (CH_NAME 1, CH_NAME 2) and TV programs (PROG_NAME 1, PROG_NAME 2), and the channel information is shown in real-time when the user identity (ID1, ID2) is watching the TV program. Since the interactive channel menu 30 includes the user list and the corresponding channel list, as shown in FIG. 3, a channel information shown on the interactive channel menu 30 varies in real time when one of the user identities in the user list selects the channel information. Namely, the channel list comprises a plurality of channel information corresponding to the plurality of user identities of the user list, respectively. Each of the plurality of channel information includes a TV channel program being watched by a user corresponding to a user identity of the user list. Finally, a viewer can select the user identify from the interactive channel menu 30 for the audio and video broadcast device to broadcast a TV program corresponding to the channel information according to a user control command (Step 230). Therefore, utilizing the above process 20, the user can obtain the channel information selected by the other users corresponding to the plurality of user identities of the user list, and thus, can switch TV channels according to the selection of the other users of the user list, so as to increase the interaction with the other users.

Please note that the audio and video broadcast device may further comprise a communications features module, providing online feature, such as Internet functions and, etc., so that the user can register a user identity through a web server and obtain the user identities corresponding to the other users for forming the user list. On the other hand, when watching a TV program, the user can also share the selected channel information related to the TV program through the web server and receive the channel information selected by the other users of the user list. The related communications technique is well known by those skilled in the art, and thus not narrated herein.

Preferably, the user list can be a contact list or a friend list, and each of the plurality of channel information on the channel list comprises a TV channel number, a TV channel name, the name of the TV program broadcasted on the TV channel, a scheduled recording information, and so on. Therefore, when the user wants to watch TV programs, he or she can obtain the selected channel information of each user on the interactive channel menu according to the user list and the corresponding channel list, and thus, can further take the selected channel information as reference for switching TV channels. Additionally, the plurality of user identities on the user list can be further organized into a plurality of groups, such as classmate groups, family groups, friend groups, or the user identities can be grouped according to interests or preferences, such as a movie lovers group, sports groups, and so on. For example, if a best friends group is included in the user list of a user A, whenever the user A wants to watch TV programs, the channel information corresponding to the best friends group can be considered a priority choice for the user A to select a most desired program. Compared with the conventional electronic program guide (EPG) in which the user has to select a TV channel from dozens or even hundreds of TV channels for watching TV programs, the present invention can reduce the selection range from all of the TV channels to several groups, among which the user can select a favorite TV channel to broadcast or to record, so that not only the time for selecting TV programs can be saved, but the accuracy can also be enhanced. Furthermore, taking another example, since there exist a lot of sporting events around the world, and if a user B only prefers watching ball game programs, the user B can then check a ball game loving group for obtaining the channel information about whether ball game programs are broadcasted, or can directly select a ball game program from the ball game programs watched by the ball game loving group.

Please refer to FIG. 3 again. FIG. 3 is a schematic diagram of an example of an interactive channel menu 30 according to an embodiment of the present invention. The interactive channel menu 30 can be displayed on a screen 310 of an audio and video broadcast device 300, and includes a user list 31 and a channel list 32. The user list 31 can be a contact list or a friends list of the user, and includes user identities ID1˜IDn. The user list 31 can be obtained and updated from a web server through the Internet, or can be inputted manually by the user to store in a storage unit of the audio and video broadcast device 300 (not shown in FIG. 3). When the user wants to watch TV programs and enables a channel information sharing function, the audio and video broadcast device 300 can then receive the channel list 32 corresponding to the user list 31 from the web server. The channel list 32 comprises channel information CH1˜CHn corresponding to the user identities ID1˜IDn of the user list 31, respectively, among which each channel information further comprises a channel name CH_NAME and a related program name PROG_NAME. In this case, when the user wants to watch TV, the user can obtain the selected channel information of each user on the user list 31 according to the user list 31 and the corresponding channel list 32, and thus, can further take the selected channel information as reference for selecting TV programs, so as to increase the interaction with other users. Certainly, the user list can be updated regularly or irregularly from the web server, or new user identities can be manually inputted by the user at any time.

On the other hand, the interactive channel menu 30 of the present invention can update the channel information CH1˜CHn of the channel list 32 regularly or irregularly through the web server for immediately acquiring the latest channel information of the other users. Or otherwise, the interactive channel menu 30 can update the channel information CH1˜CHn through control of software or by manual settings of the user. Therefore, the user can make corresponding responses, like switching TV channels, according to variation of the channel information of the interactive channel menu 30. For example, the user can know whether there are new users or any channel information being switched when the interactive channel menu 30 updates once every half an hour or every hour based on the settings of the user. Certainly, the update of the interactive channel menu 30 can be activated at any time whenever the user wants to know whether there are new users or any channel information being switched, or can be triggered automatically as soon as other users of the user list 31 switch TV channels, new TV programs start, or there are new users participating in watching TV programs.

In addition, the interactive channel menu 30 of the present invention further comprises a tracking function. When the channel information selected by the user according to a user identity changes, the interactive channel menu 30 can pop-up a dialogue window for inquiring the user whether to follow the trail of the user identity through automatically switching TV channels. For example, if the user has already selected a TV channel corresponding to the user identity ID1, but at this time the channel information CH1 corresponding to the user identity switches to another TV channel, the interactive channel menu 30 can automatically follow the variation of the channel information to switch the TV channel broadcasted by the audio and video broadcast device 300 to another TV channel which is selected by the user identity ID1 currently. Please note that the tracing function of the interactive channel menu 30 can certainly comprise other implementation methods, which also belong to the range of the present invention.

In the present invention, the channel information of the interactive channel menu can further comprise scheduled recording Information, which is utilized for storing scheduled program recording Information corresponding to each user identity, such as periods and channels of scheduled recording TV programs. Further, in the present invention, the user can also schedule a video recording based on TV programs watched by the user identities in the future. That is to say, the user can take other users as references for scheduling to make video recording in different periods. For example, the user can schedule to make a video recording according to the TV program watched by a first user in a first period and to make another video recording according to another TV program watched by a second user in a second period. This function is preferably enabled in a situation where specific users are used to watching specific programs. For example, in the daytime, if the user wants to schedule to record a baseball game broadcasted at seven o'clock in the evening, the broadcasting time can easily be changed due to an uncertain start time of the ball game, such as being advanced to six thirty or postponed to seven thirty, with a result that the recorded video may lose some part of the ball game or have irrelevant programs. Thus, if the user is sure that the user A (from the above-mentioned ball game loving group of the user list) will watch the ball game broadcast in the evening, the audio and video broadcast device 300 can be scheduled to enable video recording according to “the channel information selected by the user A in the evening”, so as to increase the accuracy for recording TV programs in advance.

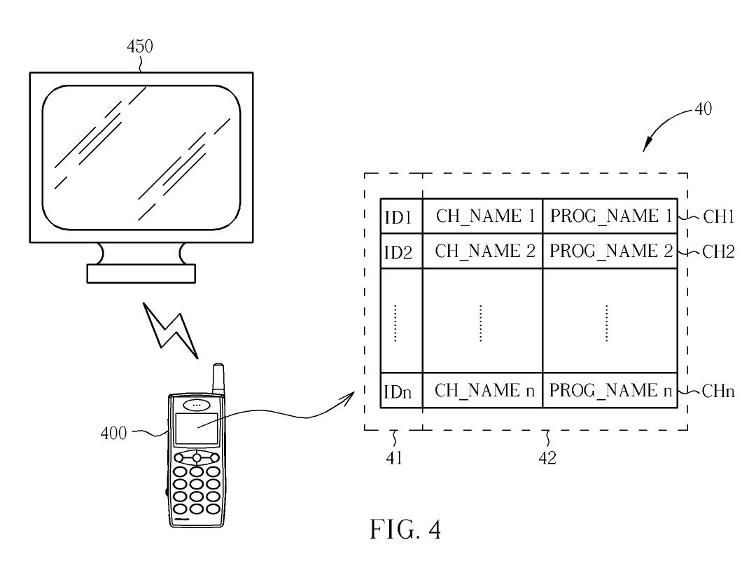

Please further refer to FIG. 4. FIG. 4 is a schematic diagram of an interactive channel menu 40 according to another embodiment of the present invention. The difference with the above-mentioned embodiment is that the interactive channel menu 40 is shown on a mobile communications device 400, and thus a user list 41 of the interactive channel menu 40 can be formed by a contact list of the mobile communications device 400 after the mobile communications device 400 communicates with the web server. For example, the mobile communications device 400 of the present invention can compare user identities of the contact list with data stored in the web server to synchronize and form the user list 41 of the interactive channel menu 40. In this case, the mobile communications device 400 can receive a channel list 42 corresponding to the user list 41, so that the user can select TV channel information to control an audio and video broadcast device 450 for broadcasting corresponding TV programs according to channel information CH1˜CHn of the channel list 42. In addition, the user can immediately communicate with the other users through the mobile communications device 400 (for example, making a phone call) to exchange feelings about the currently watched TV program, so as to enhance the interaction when watching TV. Please note that the mobile communications device 400 can be a cell-phone, a PDA, and the like, and after synchronizing with the web server, the mobile communications device 400 can also be operated like a remote control which shows the interactive channel menu 40 when selecting the contact list of the mobile communications device 400, so as to be capable of performing channel switching directly. Preferably, after synchronization, the contact list of the mobile communications device 400 can be classified into categories such as an overlapping part of user identities originally existing in the contact list of the mobile communications device 400 and that received from the web server; and a not-overlapping part of the same. Certainly, new user identities can be added in the user list 41 of the mobile communications device 400 at any time.

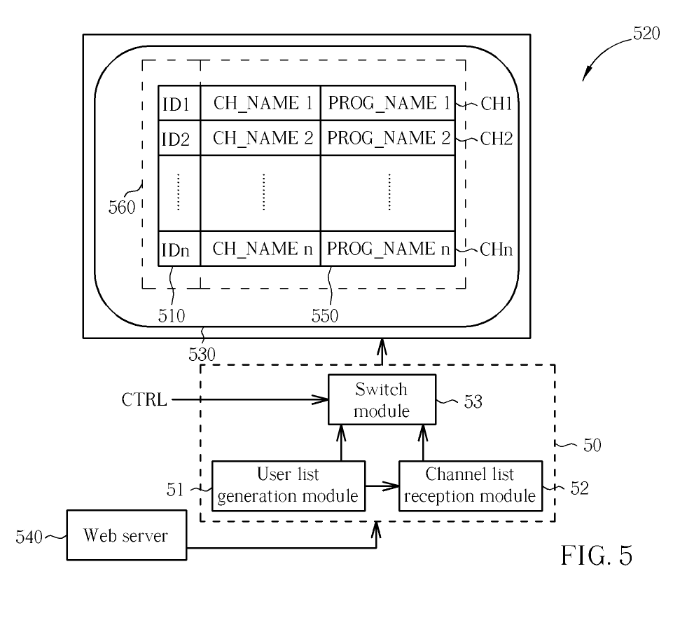

Please refer to FIG. 5. FIG. 5 is a schematic diagram of an electronic device 50 for switching channels in an audio and video broadcast device according to the present invention. The electronic device 50 is utilized for realizing the process 20 of the present invention, and comprises a user list generation module 51, a channel list reception module 52 and a switch module 53. The user list generation module 51 is utilized for generating a user list 510, which is displayed on a screen 530 of an audio and video broadcast device 520. The channel list reception module 52 is coupled to the user list generation module 51, and is utilized for receiving a channel list 550 corresponding to the user list 510 through a web server 540, such that an interactive channel menu 560 formed with the user list 510 and the channel list 550 corresponding to the user list 510 can be displayed on the screen 530 of the audio and video broadcast device 520. The switch module 53 is utilized for selecting a channel information from channel information CH1˜CHn of the channel list 550 to control the audio and video broadcast device 520 for broadcasting a corresponding TV program according to a user control command CTRL. Preferably, the electronic device 50 can be realized by a microprocessor of the audio and video broadcast device 520 and a program code stored in a storage unit (such as a flash memory), which is well known by those skilled in the art and not narrated herein. The electronic device 50 can also be integrated on a mobile communications device for realizing the embodiment in FIG. 4.

As mentioned above, through receiving the channel list corresponding to the user list and showing an interactive channel menu, the user can obtain the channel information selected by other users and take the channel information as a reference for performing channel switching when watching TV programs, so as to enhance the interaction with the other users.

Those skilled in the art will readily observe that numerous modifications and alterations of the device and method may be made while retaining the teachings of the invention.

What is claimed is:

1. A method for switching channels in an audio and video broadcast device comprising:
forming a user list comprising a plurality of user identities;
generating an interactive channel menu by matching the user list with a channel list comprising a plurality of channel information, wherein a channel information of the plurality of channel information shown on the interactive channel menu varies when one of the user identities corresponding to the channel information selects the channel information; and
selecting the channel information from the interactive channel menu to broadcast the same channel information corresponding to the user identity through a user control command.

2. The method of claim 1, wherein forming the user list comprises forming the user list according to user data stored in a web server or data generated by users.

3. The method of claim 1, wherein forming the user list comprises updating the user list according to user data stored in a web server.

4. The method of claim 3, wherein updating the user list according to the user data stored in the web server comprises at least one of the following steps: regularly updating the user list, updating the user list when the user data stored in the web server changes, and updating the user list through a user update command.

5. The method of claim 1, wherein generating the interactive channel menu comprises receiving the channel list corresponding to the user list from a web server.

6. The method of claim 5, wherein receiving the channel list corresponding to the user list from the web server comprises at least one of the following steps: regularly updating the channel list from the web server, updating the channel list from the web server through a user update command, and updating the channel list from the web server when data stored in the web server changes.

7. The method of claim 1 further comprising switching channels according to variation of the selected channel information.

8. The method of claim 1, wherein the user list is a contact list comprising user nicknames, user diagrams, and user status.

9. The method of claim 8, wherein the contact list is stored in a mobile communications device, the method further comprising:
receiving the channel list by the mobile communications device; and
selecting the channel information from the channel list to control the audio and video broadcast device for broadcasting the TV program corresponding to the channel information by the mobile communications device through the user control command.

10. The method of claim 9, wherein receiving the channel list by the mobile communications device comprises performing synchronization and comparison to receive the channel list according to data stored in a web server and user identities of the contact list.

11. The method of claim 1, wherein forming the user list comprises dividing the plurality of user identities into a plurality of groups according to relationship, interests or preferences of users corresponding to the plurality of user identities.

12. The method of claim 1, wherein each of the plurality of channel information comprises a scheduled recording Information, and the scheduled recording Information comprises control information utilized for storing scheduled recording program information of corresponding user identities and for controlling the audio and video broadcast device to make a video recording accordingly.

13. An electronic device for switching channels in an audio and video broadcast device comprising:
a user list generation module for generating a user list, the user list comprising a plurality of user identities;
a channel list reception module, coupled to the user list generation module, for receiving a channel list corresponding to the user list, wherein the channel list comprises a plurality of channel information corresponding to the plurality of user identities of the user list, respectively; and
a switch module for selecting a channel information from the channel list to control the audio and video broadcast device for broadcasting a TV program corresponding to the channel information according to a user control command;
wherein the user list and the channel list corresponding to the user list form an interactive channel menu for being displayed on a screen of the audio and video broadcast device.

14. The electronic device of claim 13, wherein the user list generation module generates the user list according to data stored in a web server or data generated by users.

15. The electronic device of claim 13, wherein the user list generation module further updates the user list according to data stored in a web server.

16. The electronic device of claim 15, wherein the user list generation module further updates the user list regularly, updates the user list when the data stored in the web server changes, or updates the user list through a user update command.

17. The electronic device of claim 13, wherein the channel list reception module receives the channel list corresponding to the user list from a web server.

18. The electronic device of claim 17, wherein the channel list reception module further regularly receives updated channel list from the web server, receives updated channel list from the web server through a user update command, and receives updated channel list from the web server when data stored in the web server changes.

19. The electronic device of claim 13, wherein the switch module further switches channels according to variation of the selected channel information.

20. The electronic device of claim 13, wherein the user list comprises a contact list comprising user nicknames, user diagrams, and user status.

21. The electronic device of claim 13, wherein the electronic device is a mobile communications device.

22. The electronic device of claim 21, wherein the user list is a contact list stored in the mobile communications device.

23. The electronic device of claim 22, wherein the channel list reception module further performs synchronization and comparison to receive the channel list according to data stored in a web server and user identities of the contact list.

24. The electronic device of claim 13, wherein the user list comprises a plurality of groups divided according to relationship, interests or preferences of users corresponding to the plurality of user identities.

25. The electronic device of claim 13, wherein each of the plurality of channel information comprises a scheduled recording Information, and the scheduled recording Information comprises a control information utilized for storing scheduled recording program information of corresponding user identities and for controlling the audio and video broadcast device to make a video recording accordingly.
